(19) United States
(12) Patent Application Publication
(10) Pub. No.: US 2005/0151511 A1
(43) Pub. Date: Jul. 14, 2005

(54) Transferring power between devices in a personal area network

(75) Inventor: Ram V. Chary, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: INTEL CORPORATION

(21) Appl. No.: 10/757,914

(22) Filed: Jan. 14, 2004

(51) Int. Cl. G06F 1/26

(52) U.S. Cl. 320/127

(57) ABSTRACT

Systems and methods of delivering power provide for using a battery charging circuit to transfer power from a source device in a network to a first receiving device in the network. The circuit can also be used to transfer power from the source device to a second receiving device, where the first and second receiving devices are different types of devices. A pool of power can therefore be established for the network, where the pool derives its power from the devices in the network and can be used to deliver power between devices in the network. The use of a standardized circuit to transfer the power between the devices also eliminates the need for a dedicated battery charger for each device. In the case of a personal area network, the different types of devices may include personal computers, personal digital assistants, digital cameras, wireless phones, media players, wireless headsets, etc.

### BACKGROUND

1. Technical Field

Embodiments of the present invention generally relate to delivering power to devices. More particularly, embodiments relate to the use of a power pool to transfer power between devices in a personal area network.

2. Discussion

The personal computer (PC) plays a major role in the functionality of devices such as personal digital assistants (PDAs), digital cameras, wireless smart phones, media players and wireless headsets, as it is used as a communication and storage hub for these “satellite” devices to form a personal area network (PAN). For example, many consumers download pictures from digital cameras and wireless phones to PCs and synchronize their PDAs with their PCs. In the case of media players, PCs can play a key role in the archival and downloading of multimedia content (e.g., audio, video) for the players. In addition, it is not uncommon for Bluetooth® (e.g., Bluetooth Special Interest Group/SIG, Core Specification v1.2, November 2003) enabled wireless headsets to play audio content received from nearby media players, PCs and/or smart phones.

While the ability to interface these devices with one another is desirable to consumers, it presents a number of challenges to consumer product designers as well as manufacturers. One particular area of concern relates to power delivery because the disparate power requirements of the devices in the typical PAN result in each device having its own power source (typically a battery) and a dedicated external alternating current (AC) adapter/charger to recharge the battery. For example, an external battery charger for a Nokia® 5110 series mobile phone cannot be used to recharge the battery of a Compaq iPAQ® 5400 series pocket PC. Accordingly, when a consumer desires to travel with multiple devices, all of the corresponding chargers must be brought along as well. It has been determined that the necessary number of cables, adapters, chargers and/or charging cradles can be rather burdensome on the traveler.

Indeed, it has been determined that the typical “road-warrior” can been found with a mobile PC (or laptop computer), PDA, smart phone, media player and digital camera, as well as each of the external chargers for these devices. If the traveler chooses to leave the charger for one or more of the devices in the PAN behind, it is not uncommon for these devices to run out of battery power during the trip. Other devices in the PAN such as the laptop computer, however, may have a surplus of power. Conventional approaches to power delivery fail to make use of this surplus power, and therefore do not maximize the usefulness of devices whose chargers might have been left behind.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a diagram of an example of a personal area network according to one embodiment of the invention;

FIG. 2 is a block diagram of an example of a battery charging circuit having a power delivery module and a charge transfer interface according to one embodiment of the invention;

FIG. 3 is a block diagram of an example of a computer system according to one embodiment of the invention;

FIG. 4 is a diagram of an example of a laptop computer according to one embodiment of the invention;

FIG. 5 is diagram of an example of a laptop computer according to an alternative embodiment of the invention;

FIG. 6A is a diagram of an example of a personal digital assistant according to one embodiment of the invention;

FIG. 6B is a diagram of an example of an personal digital assistant according to an alternative embodiment of the invention;

FIG. 7 is a flowchart of an example of a method of delivering power according to one embodiment of the invention; and

FIG. 8 is a flowchart of an example of a process of managing a pool of power according to one embodiment of the invention.

### DETAILED DESCRIPTION

Systems and methods provide for the establishment of a “pool” of power in a network such as a personal area network, where the pool derives its power from the devices in the network and can be used to deliver power between devices in the network. Thus, the network includes one or more “source” devices, which transfer power to other “receiving” devices. Some devices can function as both a source device as well as a receiving device, where others may function only as receiving devices. The use of a standardized power transfer and charging scheme to transfer power between the devices eliminates the need for an external AC adapter/battery charger for each device. As a result, an individual traveling with multiple devices experiences a substantial reduction in the amount of supporting equipment/cables needed.

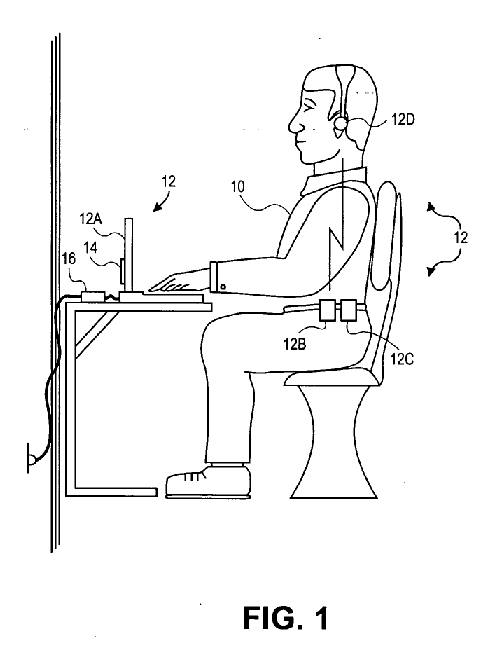

FIG. 1 shows an individual 10 with a personal area network (PAN) defined by devices 12 (12a-12d). In the illustrated example, the individual 10 is operating a laptop (or notebook) computer 12a while listening to music content, which is transmitted from a personal digital assistant (PDA) 12b to a wireless headset 12d over a wireless connection such as a Bluetooth® connection. The PDA 12b can run a wide variety of commercially available applications such as appointment scheduling, media storage, and contact management, and is typically able to synchronize data with the computer 12a. The individual 10 is also carrying a wireless phone 12c, which may also be enabled with “smart phone” features such as appointment scheduling, media storage and contact management. It should be noted that the illustrated PAN devices 12 are merely examples of the types of devices that can be used in a PAN. For example, the wireless headset 12d could receive the music content from a media player such as a Moving Picture Experts Group Layer-3 Audio (MP3) player. Indeed, a wide variety of devices can readily benefit from the principles described herein.

The computer 12a is configured to function as a source device and includes a lid with an inductive coupling charge transmitter 14. The inductive coupling charge transmitter 14 is one type of charge transfer interface that may be used. The computer 12a can transfer power through the charge transmitter 14 to the other devices 12b-12d in the personal area network when the devices are positioned on or near the charge transmitter 14. For example, the wireless headset 12d can be placed on the charge transmitter 14 in order to access the power available from the computer 12a. In addition, the wireless phone 12c could be placed on the charge transmitter in order to recharge the battery within the phone 12c. The same is true for the PDA 12b and any other devices in the personal area network. Accordingly, when traveling the illustrated individual 10 can simply carry the alternating current (AC) adapter 16 associated with the computer 12a. Alternatively, the individual 10 could leave behind the AC adapter 16 as well and rely on the DC power provided by the battery of the computer 12a. If the computer 12a is powered by a fuel cell, the latter approach may be particularly desirable.

While some examples make reference to mobile PCs (i.e. “laptop” or “notebook” computers), the embodiments of the invention are not so limited. Indeed, desktop and home entertainment computers can be readily incorporated into the power transfer schemes described herein without parting from the spirit and scope of the embodiments. Notwithstanding, there are a number of aspects of mobile PCs for which the embodiments are well suited.

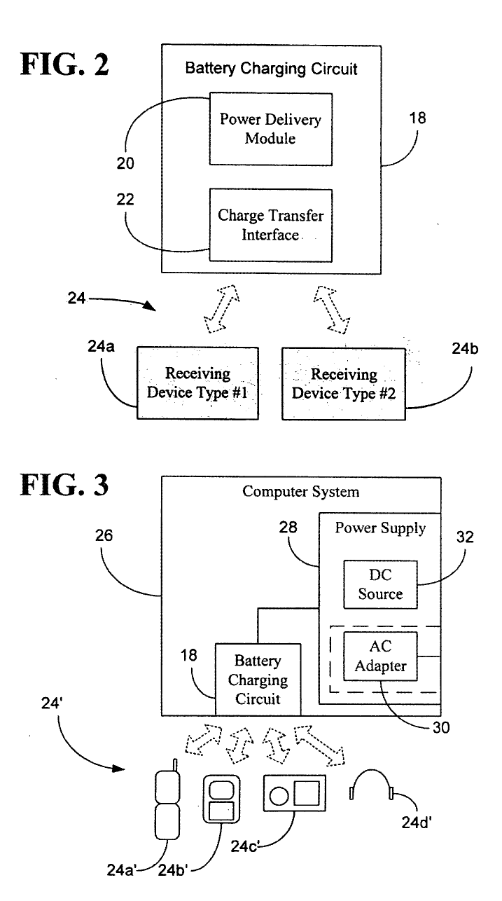

Turning now to FIG. 2, a battery charging circuit 18 is shown, where the battery charging circuit 18 has a power delivery module 20 and a charge transfer interface 22 operatively coupled to the power delivery module 20. The power delivery module 20 transfers power from a power supply (not shown) through the charge transfer interface 22 to different types of receiving devices 24 (24a, 24b). Thus, a first type of receiving device 24a might be PDA 12b (FIG. 1) and a second type of receiving device 24b might be wireless phone 12c (FIG. 1). In another example, the first type of receiving device 24a could be laptop computer 12a (FIG. 1) and the second type of receiving device 24b could be wireless headset 12d (FIG. 1). Other types of devices such as digital cameras and medial players can also function as receiving devices.

As already noted, under conventional approaches different types of devices require different external AC adapters/battery chargers. For example, a PDA charger typically cannot be used to transfer power to a wireless phone (and vice versa). Indeed, PDAs from different manufacturers typically do not have compatible battery chargers. In some cases, even different models of a device from the same manufacturer require different battery chargers (e.g., one model might require a nine-pin connector while another model might require a six contact charging cradle). The receiving devices 24 in the illustrated embodiment, on the other hand, have been modified to be compatible with the common charge transfer interface 22 and represent a significant departure from the conventional approach to delivering power to devices in a PAN.

FIG. 3 shows a computer system 26 with battery charging circuit 18 (FIG. 2), where the battery charging circuit 18 is used to transfer power from a power supply 28 through the charge transfer interface 22 (FIG. 2) to different types of receiving devices 24′ (24a′-24d′). In the illustrated example, the first type of receiving device is a wireless phone 24a′, the second type of receiving device is a PDA 24b′, the third type of receiving device is a digital camera 24c′ and the fourth type of receiving device is a wireless headset 24d′. As already noted, the specific types of devices 24′ can vary depending upon the circumstances. The power supply 28 can include an external AC adapter 30 and/or a direct current (DC) power source 32 such as a rechargeable battery or a fuel cell. Thus, the receiving devices 24′ effectively use the power source 32 of the computer system 26 to recharge their respective internal batteries.

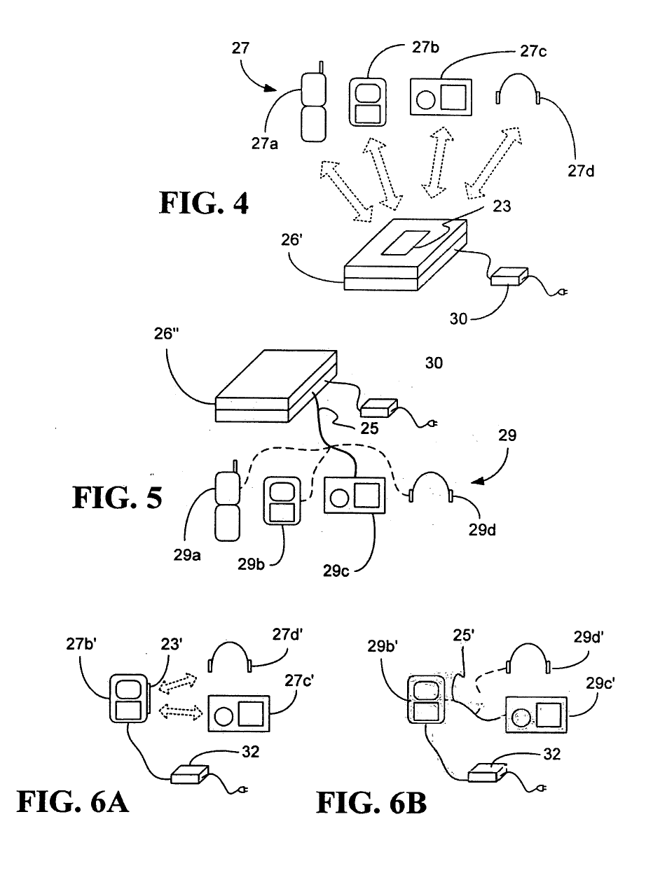

Turning now to FIGS. 4 and 5, it can be seen that the charge transfer interface may be implemented in a number of different ways. For example, one approach is to equip a computer system 26′ with an inductive coupling charge transmitter 23 in order to transfer power to receiving devices 27 (27a-27d). The inductive coupling charge transmitter 23 can therefore be readily substituted for the charge transfer interface 22 (FIG. 2) already discussed. While the illustrated charge transmitter 23 is shown as being coupled to a lid of the computer system 26′, other physical arrangements can be used without parting from the spirit and scope of the embodiments of the invention. Inductive coupling battery charging, which is a well understood technique, uses a coil located in the source device as a first winding of a transformer and a coil located in the receiving device as a second winding of the transformer. The result is a contactless transfer of power between the two devices when they are brought in proximity to one another and a current is applied to one of the windings.

As shown in FIG. 5, another approach is to provide a computer system 26″ with a universal serial bus (USB 2.0, USB Implementers Forum, Inc./USB-IF, November 2001) cable 25. The USB cable 25 can therefore also be substituted for the charge transfer interface 22 (FIG. 2) discussed above. The computer system end of the cable 25 has a standard USB structure and the receiving device end of the cable 25 has a structure that is compatible with each of the receiving devices 29 (29a-29d). While no particular arrangement is required for the receiving device end of the cable 25, a standardized format facilitates the use of the cable 25 across multiple types of devices, models and/or manufacturers. Furthermore, if the USB cable 25 configuration is used, the computer system 26″ is also able to transfer data through the battery charging circuit to the receiving devices 29.

FIGS. 6A and 6B demonstrate that PAN devices other than traditional laptop and desktop computers can also function as source devices in the transfer of power. Simply put, the power supplies of multiple devices in the PAN can be a source of power to the pool. In the example illustrated in FIG. 6A, the PDA 27b′ transfers power to the digital camera 27c′ and the wireless headset 27d′ through an inductive coupling charge transmitter 23′. The transferred power can be derived from an internal battery (not shown) of the PDA 27b′ or an AC adapter 32 associated with the PDA 27b′. The extent to which a device can function as a source device can be a function of the capacity of the battery in the device, the form factor (i.e., size) of the device and the type of charge transfer interface being used. For example, wireless headsets typically have a relatively small form factor and often operate on a battery similar to a watch battery. Accordingly, it is unlikely that a wireless headset would support a charge transmitter or a USB port. A PDA, on the other hand, may be able to support a USB slot but not a charge transmitter. As already discussed, a laptop computer typically has a large enough form factor to support a charge transmitter as well as a USB port.

In FIG. 6B, the PDA 29b′ transfers power to the digital camera 29c′ and the wireless headset 29d′ through a USB cable 25′. The USB cable 25′ may be the same or a different cable than USB cable 25 (FIG. 5) already discussed. The transferred power can be derived from an internal battery (not shown) of the PDA 29b′ or an AC adapter 32 associated with the PDA 29b′.

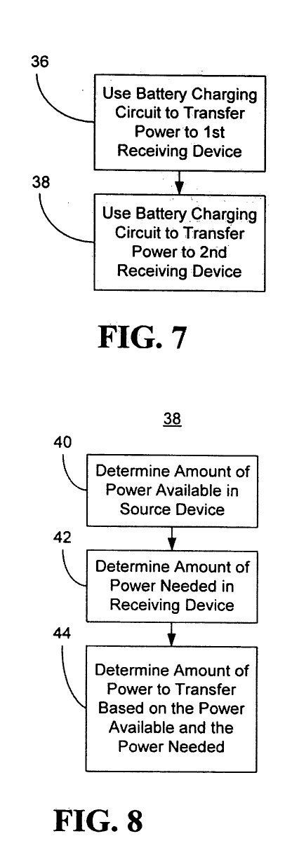

FIG. 7 illustrates a method 34 of delivering power. Method 34 can be implemented in a power delivery module of a source device such as the illustrated power delivery module 20 (FIG. 2) using a wide variety of commercially available hardware and/or software programming techniques. For example, method 34 may be readily implemented as an application specific integrated circuit (ASIC) or as a set of instructions to be stored in a machine-readable medium such as a read only memory (ROM), random access memory (RAM), flash memory, etc. Processing block 36 provides for using a battery charging circuit to transfer power from a source device in a PAN to a first receiving device in the PAN. Block 38 provides for using the battery charging circuit to transfer power from the source device to a second receiving device in the PAN, where the first and second receiving devices are different types of devices. As already noted, different types of devices include, but are not limited to, personal computers, PDAs, wireless phones, wireless headsets, digital cameras, media players, and so on.

Turning now to FIG. 8, a process of managing a pool of power is shown in blocks 38. The illustrated process can be incorporated into the above described method 34 (FIG. 7) of delivering power, and can be performed for each receiving device in need of power. Processing block 40 provides for determining an amount of available power in the source device and block 42 provides for determining an amount of needed power in the receiving device. The amount of available power can be determined based on the mode in which the source device's power supply is operating (e.g., AC or DC), a predetermined percentage of the full battery capacity in the source device, the applications running on the source device, the type of charge transfer interface being used (e.g., USB cable or inductive coupling charge transmitter), and so on.

For example, inductive coupling charge transmitters typically have a greater charging capacity than standard USB cables. Thus, if the source device is using an inductive coupling charge transmitter it may be determined that relatively high amount of power is available. On the other hand, USB cables typically have less energy loss (i.e., transfer overhead) and are more efficient than inductive coupling charge transmitters. Accordingly, it may alternatively be determined that the amount of power available from a source device with a USB cable is greater than (or approximately equal to) an equivalent source device with an inductive coupling charge transmitter. In this regard, if multiple types of charge transfer interfaces are available (as in the case of a digital camera having a receiving device brought into proximity with its inductive coupling charge transmitter while data is being transferred to the receiving device over a USB cable), a decision can be made as to which interface to use based on transfer efficiency.

The amount of needed power can be determined based on a predetermined percentage of full battery capacity in the receiving device (e.g., 25%), the applications running on the receiving device, etc. Block 44 provides for determining the amount of power to transfer based on the needed power and the available power. The determination at block 44 can be a simple denial of power transfer if the amount of needed power exceeds the amount of available power. Alternatively, the determination at block 44 can result in the transfer of a fraction of the amount of needed power if the amount of needed power exceeds the amount of available power. In yet another example, the source device and the receiving device can negotiate the transferred amount at block 44 if the amount of needed power exceeds the amount of available power. Thus, the illustrated process takes into account the relative power needs of the devices in the PAN and provides an enhanced mechanism of ensuring that power is distributed appropriately.

Those skilled in the art can appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. A method of delivering power comprising:
using a battery charging circuit to transfer power from a source device in a network to a first receiving device in the network; and
using the battery charging circuit to transfer power from the source device to a second receiving device in the network, the first and second receiving devices being different types of devices.

2. The method of claim 1, wherein using the battery charging circuit to transfer power from the source device includes transferring power from at least one of a computer system and a personal digital assistant.

3. The method of claim 2, wherein transferring power from the computer system includes transferring power from a laptop computer.

4. The method of claim 2, wherein transferring power from the computer system includes transferring power from a desktop computer.

5. The method of claim 1, wherein using the battery charging circuit to transfer power to the first receiving device includes transferring power to a personal digital assistant and using the battery charging circuit to transfer power to the second receiving device includes transferring power to at least one of a digital camera, a wireless phone and a wireless headset.

6. The method of claim 1, wherein using the battery charging circuit to transfer power to the first receiving device includes transferring power to a digital camera and using the battery charging circuit to transfer power to the second receiving device includes transferring power to at least one of a personal digital assistant, a wireless phone and a wireless headset.

7. The method of claim 1, wherein using the battery charging circuit to transfer power to the first receiving device includes transferring power to a wireless phone and using the battery charging circuit to transfer power to the second receiving device includes transferring power to at least one of a personal digital assistant, a digital camera and a wireless headset.

8. The method of claim 1, wherein using the battery charging circuit to transfer power to the first receiving device includes transferring power to a wireless headset and using the battery charging circuit to transfer power to the second receiving device includes transferring power to at least one of a personal digital assistant, a digital camera and a wireless phone.

9. The method of claim 1, wherein using the battery charging circuit to transfer power includes transferring power through a universal serial bus cable to the receiving devices.

10. The method of claim 1, wherein using the battery charging circuit to transfer power includes transferring power through an inductive coupling charge transmitter to the receiving devices.

11. The method of claim 1, further including:
determining an amount of available power in the source device;
determining an amount of needed power in the receiving devices; and
determining an amount of power to transfer based on the available power and the needed power.

12. The method of claim 11, further including determining that the amount of needed power exceeds the amount of available power.

13. The method of claim 12, wherein determining the amount of power to transfer includes at least one of denying power transfer, transferring a fraction of the amount of needed power and negotiating the amount of power to transfer with the receiving device.

14. The method of claim 1, further including using the battery charging circuit to transfer data from the source device to at least one of the receiving devices.

15. A battery charging circuit comprising:
a power delivery module; and
a charge transfer interface operatively coupled to the power delivery module, the power delivery module to transfer power from a power supply through the charge transfer interface to different types of receiving devices.

16. The battery charging circuit of claim 15, wherein the receiving devices are to include at least two of a personal digital assistant, a digital camera, a wireless phone, a media player and a wireless headset.

17. The battery charging circuit of claim 15, wherein the charge transfer interface includes a universal serial bus cable.

18. The battery charging circuit of claim 15, wherein the charge transfer interface includes an inductive coupling charge transmitter.

19. The battery charging circuit of claim 15, wherein the power delivery module is to determine an amount of power available from the power supply, determine an amount of power needed in the receiving devices and determine an amount of power to transfer based on the power available and the power needed.

20. A computer system comprising:
a power supply;
a power delivery module; and
a charge transfer interface coupled to the power delivery module and the power supply, the power delivery module to transfer power from the power supply through the charge transfer interface to different types of receiving devices.

21. The computer system of claim 20, wherein the receiving devices are to include at least two of a personal digital assistant, a digital camera, a wireless phone, a media player and a wireless headset.

22. The computer system of claim 20, wherein the charge transfer interface includes a universal serial bus cable.

23. The computer system of claim 20, wherein the charge transfer interface includes an inductive coupling charge transmitter.

23. The computer system of claim 20, wherein the computer system is to transfer data through the charge transfer interface to the receiving devices.

25. The computer system of claim 20, wherein the power delivery module is to determine an amount of power available in the power supply, determine an amount of power needed in the receiving devices and determine an amount of power to transfer based on the power available and the power needed.

26. The computer system of claim 20, wherein the power supply includes an alternating current (AC) adapter.

27. The computer system of claim 20, wherein the power supply includes a direct current (DC) power source.

28. The computer system of claim 27, wherein the DC power source includes a fuel cell.

29. A laptop computer comprising:
a lid;
a power supply;
a power delivery module; and
an inductive coupling charge transmitter operatively coupled to the lid, the power delivery module and the power supply, the power delivery module to transfer power from the power supply through the inductive coupling charge transmitter to different types of receiving devices, the receiving devices to include at least two of a personal digital assistant, a digital camera, a wireless phone, a media player and a wireless headset, the power delivery module to determine an amount of power available in the power supply, determine an amount of power needed in the receiving devices and determine an amount of power to transfer based on the power available and the power needed.

30. The computer system of claim 29, wherein the power supply includes an alternating current (AC) adapter.

31. The computer system of claim 29, wherein the power supply includes a direct current (DC) power source.

32. The computer system of claim 31, wherein the DC power source includes a fuel cell.
